(19) United States
(12) Patent Application Publication
(10) Pub. No.: US 2006/0214812 A1
(43) Pub. Date: Sep. 28, 2006

(54) Measurement of output voltage characteristics on dynamic logic signals

(76) Inventor: Kenneth M. Ainsworth, Aloha, OR (US)

Correspondence Address: TEKTRONIX, INC., M/S 50-LAW, P.O. BOX 500, BEAVERTON, OR, 97077, US

(21) Appl. No.: 11/089,793

(22) Filed: Mar. 25, 2005

(51) Int. Cl. G08B 21/00

(52) U.S. Cl. 340/660

(57) ABSTRACT

An apparatus for measuring Output Voltage characteristics on a dynamic logic signal at an output of a device under test (DUT) includes a comparator for comparing the voltage at the output with a threshold voltage to generate a control signal. The control signal is used to switch an appropriate current load to the output in response to the dynamic logic signal. A measurement of the voltage at the output provides the Output Voltage characteristics without requiring control of an input stimulus or a static logic level at the output.

### BACKGROUND OF THE INVENTION

The present invention relates to measuring characteristics of logic circuits, and more particularly to measuring Output Voltage characteristics on dynamic logic signals.

Logic devices typically specify Output Voltage characteristics as a function of load current. For example an Output “High” specification (V_{OH}) commonly states a minimum output voltage level, such as 2.4 V, while the device is sourcing a specified current level, such as 8 mA. A similar specification is typically made for the Output “Low” state (V_{OL}), but in this case a maximum output voltage level, such as 0.5 V, is specified while the device is sinking a specified current level, such as 8 mA. Taken together these two specifications allow a designer to calculate what kind of load may be attached to a device output, while still insuring that proper logic “High” and “Low” voltage levels are maintained.

Normally V_{OH} and V_{OL} testing is done on individual semiconductor chips using parametric test systems, such as those manufactured by Teradyne, Inc., Agilent Technologies, LTX Corporation and Credence Systems Corporation. The chip output is set to the desired output logic level (“High” or “Low”) through appropriate stimulus at its input. Then a programmable current source forces a current level at the output and the resulting voltage level is measured. Often the current source is set to a variety of values, sweeping out a curve of Output Voltage vs. Output Current. However guaranteed specifications commonly list only two values—the minimum V_{OH} at rated “high” current I_{OH} and the maximum V_{OL} at rated “low” current I_{OL}.

Once these semiconductor chips are embedded in a design application, several issues exist. First, it may be difficult to directly set and maintain the output logic state so that a forcing output current may be applied and the output voltage measured. There may not be a way to apply the stimulus that fixes the output in the desired state. Second, the output may be dynamic, moving between the “High” and “Low” states. Since the forcing output current is different between the V_{OH} case (current flow out of the device) and the V_{OL} case (current flow into the device), the dynamic case may result in the wrong load being applied for some of the time. This may result in the output being driven above and below its rated voltage limits.

What is desired is a way to ensure that the appropriate forced current load is applied to the device output without requiring control of the input stimulus or requiring a static output state.

### BRIEF SUMMARY OF THE INVENTION

Accordingly the present invention provides a way of measuring Output Voltage characteristics on dynamic logic signals

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of a circuit for measuring Output Voltage characteristics on dynamic logic signals according to the present invention.

FIG. 2 is a voltage/current graphic view for the circuit of FIG. 1 according to the present invention.

FIG. 3 is a circuit diagram view of the circuit of FIG. 1 according to the present invention.

### DETAILED DESCRIPTION OF THE INVENTION

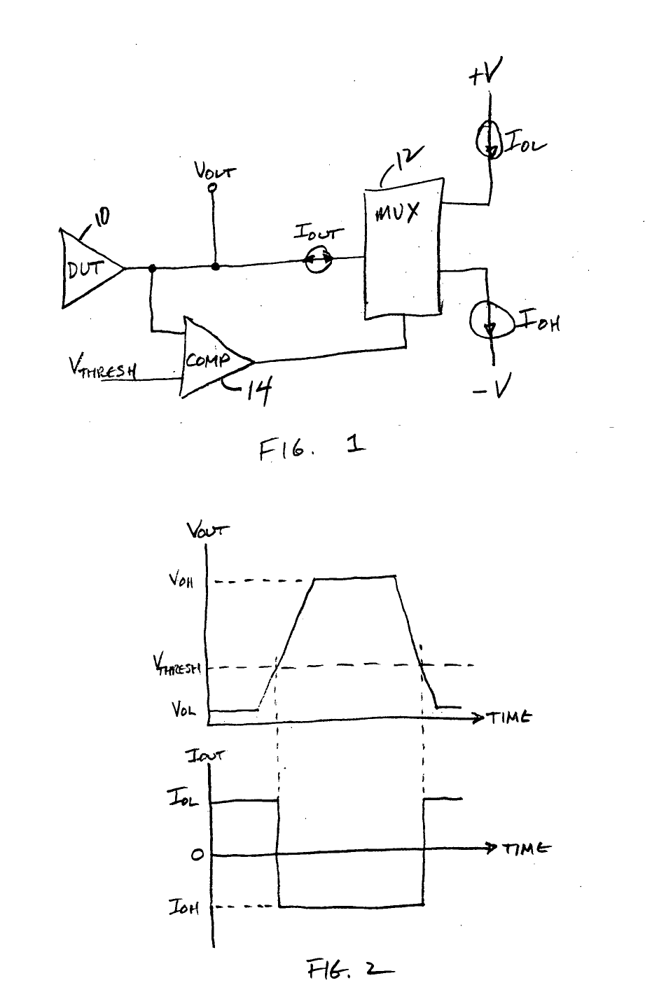

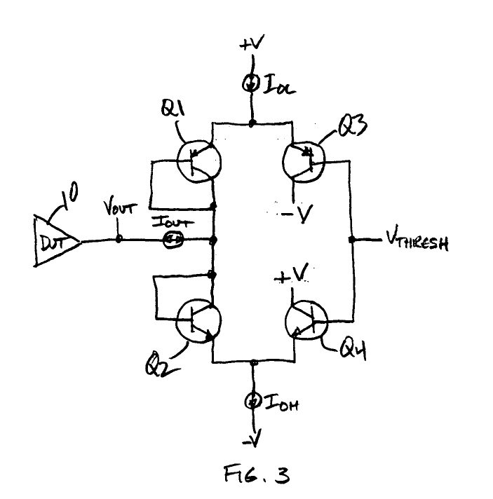

Referring now to FIG. 1 a logic device under test (DUT) 10 provides an output voltage V_{OUT} and a corresponding current I_{OUT}. The output current I_{OUT} is controlled by a multiplexer 12 having as inputs a plus voltage +V providing a current I_{OL} corresponding to a rated “low” current and a negative voltage −V providing a current I_{OH} corresponding to a rated “high” current. The output voltage V_{OUT} also is input to a voltage comparator 14 to which also is input a reference threshold voltage V_{THRESH}. The threshold voltage V_{THRESH} is chosen so that it lies in a transition region between a minimum output voltage level V_{OH} for a “High” logic state and a maximum voltage level V_{OL} for a “Low” logic state. The output from the voltage comparator 14 controls the state of the multiplexer 12. As shown in the waveform diagrams of FIG. 2, when the DUT 10 Output Voltage is more positive than V_{THRESH}, I_{OH} is coupled to the DUT output as I_{OUT}. When the DUT 10 Output Voltage is more negative than V_{THRESH}, I_{OL} is coupled to the DUT output as I_{OUT}. In this way the appropriate load is coupled in either the “High” or “Low” logic state of the DUT 10 without the requirement of controlling the output state via an input stimulus or the requirement of having a static DUT output logic state. The V_{OH} and V_{OL} levels are then measured at V_{OUT} with a voltage measurement device, such as a gated voltmeter, peak detector, oscilloscope or the like.

One potential problem with the above-described implementation is a momentary oscillation around the V_{THRESH} point. For example a DUT V_{OUT} transitioning from “high” to “low” likely shows a transition rate change, or even slope reversal, when the load I_{OH} turns off and the load I_{OL} turns on. However the DUT achieves a steady state V_{OL} with V_{OL} applied, so the oscillation is transitory as long as V_{OL} and V_{THRESH} are not too close together. Hysteresis may be added around the comparator switch point to address this problem.

A practical implementation of the circuit described above is shown in FIG. 3. A couple of emitter-coupled transistor pairs Q1, Q2 and Q3, Q4 are connected together to form the multiplexer 12 and comparator 14 functions. The emitters of Q1, Q3 are coupled to the I_{OL} source, while the emitters of Q2, Q4 are coupled to the I_{OH} source. V_{THRESH} is applied to the bases of Q3, Q4, while the collectors are coupled to voltages −V and +V respectively. The bases and collectors of Q1, Q2 are coupled to the DUT 10 output V_{OUT}. The operation of this circuit is as described above—when V_{OUT}<V_{THRESH}, I_{OUT}=I_{OL}; when V_{OUT}>V_{THRESH}, I_{OUT}=I_{OH}. In other words when V_{OUT} is greater than V_{THRESH}, transistors Q2, Q3 are turned on to couple the I_{OL} source to −V and the I_{OH} source to I_{OUT}, and when V_{OUT} less than V_{THRESH}, transistors Q1, Q4 are turned on to couple the I_{OH} source to +V and the I_{OL} source to I_{OUT}.

Thus the present invention provides an appropriate current load at the output of a logic device under test based upon a comparison of the device Output Voltage with a threshold voltage under dynamic signal conditions without the need to control input stimuli to the DUT. The Output Voltage is measured to determine the voltages for the “High” and “Low” logic states.

What is claimed is:

1. An apparatus for measuring Output Voltage characteristics on a dynamic logic signal at an output of a device under test comprising:
means coupled to the output for comparing an output voltage with a threshold voltage to generate a control signal, the threshold voltage being between a “high” state voltage level and a “low” state voltage level; and
means in response to the control signal for applying an appropriate load to the output so the “high” and “low” state voltage levels may be measured to determine the Output Voltage characteristics.
